(19) United States
(12) Patent Application Publication
(10) Pub. No.: US 2004/0213082 A1
(43) Pub. Date: Oct. 28, 2004

(54) Ice dispense agitator

(76) Inventor: Andrew J. Tobler, Franklin Park, IL (US)

Correspondence Address: Robert A. Lloyd, Pyle & Piontek, Suite 850, 221 N. LaSalle Street, Chicago, IL, 60601, US

(21) Appl. No.: 10/812,370

(22) Filed: Mar. 29, 2004

Related U.S. Application Data
(60) Provisional application No. 60/462,163, filed on Apr. 10, 2003.

(51) Int. Cl. B01F 7/00

(52) U.S. Cl. 366/325.4; 366/329.1

(57) ABSTRACT

An ice dispense agitator of a type as may be used in combination ice and beverage dispensing machines is characterized by being manufactured as an integral unit that is first cut from flat metal stock and then formed into a desired final shape by a plurality of bending operations, while requiring minimal welding.

This application claims benefit of provisional application Ser. No. 60/462,163, filed Apr. 10, 2003.

### BACKGROUND OF THE INVENTION

The present invention relates generally to ice dispensing equipment, and in particular to ice dispensing equipment utilizing a rotating agitator for moving and dispensing the ice.

Ice dispensing equipment is well known and generally employs an ice retaining bin and an ice chute that is placed in communication with ice in the bin through an electrically operated gate. Ice is dispensed from the bin by opening the gate for a flow of ice from the bin into, through and out of the chute into a suitable receptacle, and is typically initiated by actuation of a switch which operates an electrically driven dispensing mechanism that includes the gate. Also known is equipment that combines in a single unit dispensing of a beverage with an ice retaining and dispensing capacity.

All such equipment for dispensing ice either alone or together with a beverage customarily has an auger or agitator structure in the ice retaining bin that is rotated by a drive motor both during dispensing of ice and periodically. The agitator serves two purposes, in that it agitates the ice in the bin to prevent agglomeration and congealing of the discrete particles of ice into a mass of ice and it serves as part of the dispensing mechanism by moving the ice particles through the gate to the ice dispensing chute. Agitator assemblies include various arm extensions for agitating and breaking up the ice as the agitator rotates, as well as ice sweeping arm extensions having paddle or scoop ends. The scoop ends provide for contacting and lifting of the ice in the storage bin off of the bottom of the bin to an elevated ice outlet opening controlled by the gate for dispensing of the ice by gravity flow down the dispensing chute. Due to the plurality of ice breaking and sweeping arms, agitator assemblies can be relatively expensive to manufacture, in that they require the welding together of various separate components. Additionally, the assembly of an agitator must be done in a manner that provides for a robust durable structure. Accordingly, it would be desirable to have an agitator assembly that can be easily and inexpensively manufactured, but that is also sufficiently strong and not prone to deformation or breakage that would negatively impact its performance.

### OBJECTS OF THE INVENTION

An object of the present invention is to provide an ice dispensing agitator that is easily and inexpensively fabricated from flat metal stock by cutting and bending operations.

Another object is to provide such an agitator that requires minimal welding in its manufacture, yet is strong and not prone to damage in use.

### SUMMARY OF THE INVENTION

The present invention provides an improved ice dispense agitator structure and method of manufacturing the same. The agitator is cut from flat metal stock to form a unitary structure which is then bent along bend lines to a desired final shape of the agitator. Because the agitator is an integral unit, only minimal welding is required in its fabrication.

In accordance with the ice dispense agitator structure contemplated by the invention, an ice dispense agitator is fabricated from flat metal stock that is cut and bent in particular manners. As cut from the metal stock, the agitator comprises a unitary agitator body that includes the coplanar elements of a central hub having an axis of rotation, a plurality of elongate ice sweeping arms extending radially outward from the hub in angular spaced relationship, and at least one elongate ice agitating blade extending outward from a side edge of an associated one of the ice sweeping arms. As bent, the agitator comprises the unitary agitator body in which a portion of an end of each ice sweeping arm is attached to the remainder of the arm by a bent portion of the arm to provide an ice moving paddle on an end of each ice sweeping arm, and in which the at least one ice agitating blade is attached to the side edge of the associated ice sweeping blade by a bent portion of the agitator body, so that the plane of the at least one ice agitating blade extends out of the plane of its associated ice sweeping arm. The at least one ice agitating blade is L-shaped and has a pair of legs attached by a bent portion of the ice agitating blade, one leg of the L-shaped blade is connected to the associated ice sweeping arm by the bent portion of the agitator body and the other leg of the L-shaped blade has an end edge portion that extends along and adjacent and is welded to the associated one of the ice sweeping arms.

In accordance with a method of making an ice dispensing agitator, a unitary agitator body is cut from flat metal stock to provide the unitary agitator body with the coplanar elements of a central hub having an axis of rotation and a plurality of elongate ice sweeping arms extending radially outward from the hub in angular spaced relationship, which ice sweeping arms have end portions and transverse extensions at the end portions. The unitary agitator body is also provided with at least one elongate ice agitating blade that extends from a side of an associated one of the ice sweeping arms intermediate the hub and the end portion of the ice sweeping arm Included are the steps of bending the end portion of each ice sweeping arm out of the plane of the part of the ice sweeping arm between the end portion and the central hub; bending the transverse extension of each ice sweeping arm out of the plane of the end portion of the ice sweeping arm; and bending the at least one ice agitating arm out of the plane of its associated ice sweeping arm.

The foregoing and other objects, advantages and features of the invention will become apparent upon a consideration of the following detailed description, when taken in conjunction with the accompanying drawings.

### BRIEF DESCRIPTION OF THE DRAWINGS

FIG. 1 is a perspective view of an ice/beverage dispenser of a type in which an agitator embodying the teachings of the present invention may be used;

FIG. 2 is a partial cross-sectional side elevation view of the dispenser of FIG. 1;

FIG. 3 shows a top plan view of an ice dispense agitator according to the present invention, as cut from metal stock, and

FIG. 4 is a perspective view of a completed ice dispense agitator agitator of the present invention.

### DETAILED DESCRIPTION

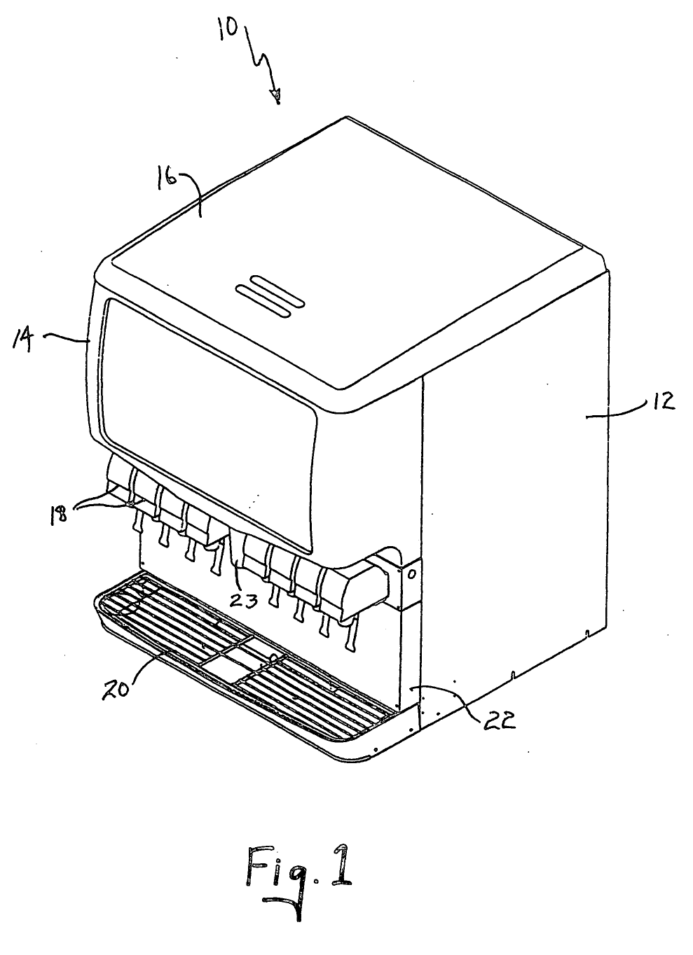

The present invention provides and improved ice dispense agitator or auger that is particularly adapted for use in a combined ice and beverage dispensing machine of the general type shown in FIG. 1 and indicated generally at 10. As is conventional, the ice/beverage dispenser 10 includes an outer housing 12, a merchandising cover 14 and a removable ice bin filling cover 16. A plurality of beverage dispensing valves 18 are secured to a front surface of the dispenser 10 above a drip tray 20 and adjacent to a splash panel 22. An ice dispensing chute 23 is also secured to the front surface of the dispenser centrally of the beverage dispensing valves 18 and above the drip tray 20.

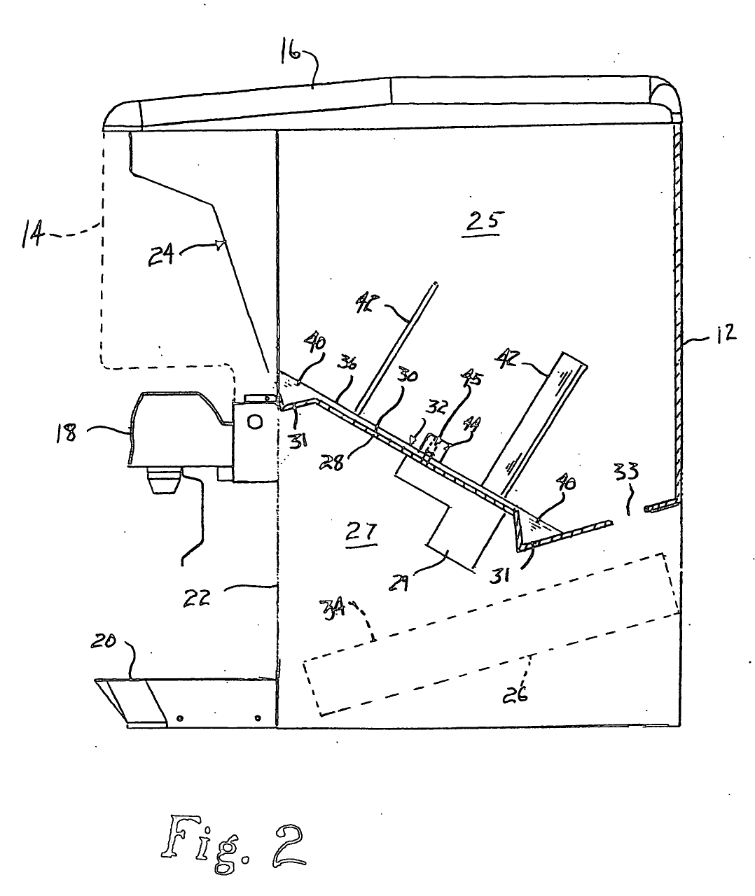

With reference to FIG. 2, the ice/beverage dispenser 10 also includes a hopper or bin 24 defining therewithin an ice retaining compartment 25. A cold plate 26 is located in a compartment 27 beneath the ice bin 24 and the ice bin has a front wall 28 for mounting on its lower surface an agitator drive motor 29. An upper surface 30 of the wall 28, opposite from the agitator drive motor, is configured to define an annular ice directing trough 31. The drive motor 29 serves to rotate an ice dispense agitator or auger, indicated generally at 32, within the ice retaining compartment 25 of the ice bin 24, which agitator advantageously is manufactured according to the present invention and serves to mix and agitate ice particles retained within the ice bin 24 to prevent congealing and agglomeration of the ice particles into a mass of ice, and also to move ice particles through the ice bin trough 31 to and through an outlet opening from the ice bin and into the chute 23 for dispensing of the ice into a cup. Rotation of the agitator 32 also causes a portion of the ice retained within the ice bin 24 to fall through a bottom opening 33 in the wall 28 into the lower compartment 27 and onto a heat exchange top surface 34 of the cold plate 26.

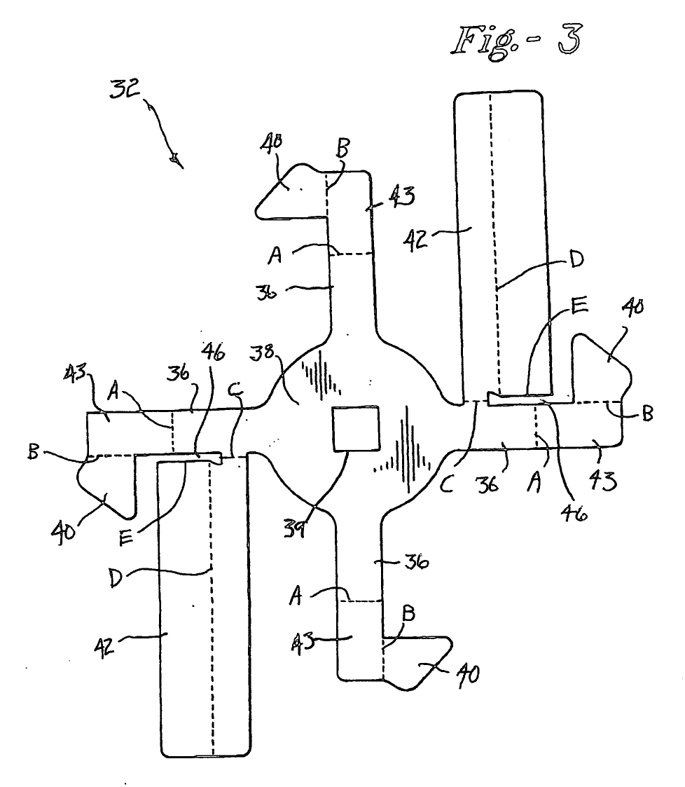

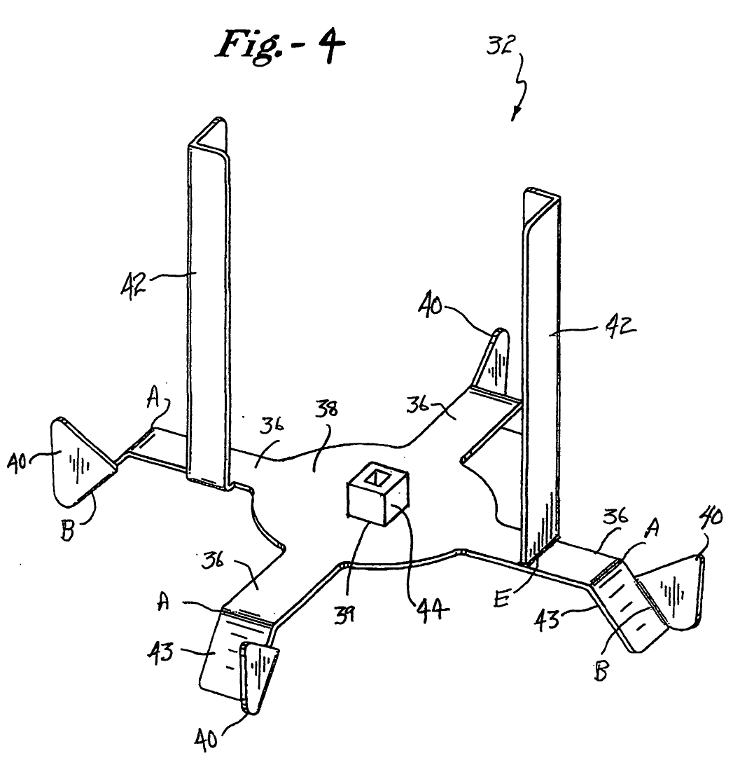

An understanding of the structure and method of fabricating the ice dispense agitator 32 can be had by reference to FIGS. 3 and 4. The agitator is initially cut from flat metal stock, which may be flat sheet metal stock of sufficient thickness, as a one-piece or unitary structure according to the pattern shown in FIG. 3. As cut from flat metal stock, the agitator 32 includes four generally rectangular ice sweeping arms 36 extending radially outward apart from a central generally circular hub portion 38 at angular spacings of about 90°. The hub is provided with a central square passage 39 at an axis of rotation of the hub, for receiving a complementary configured output shaft 45 of the drive motor 29. Each ice sweeping arm 36 terminates at its outer end in an ice moving paddle 40 that extends outward from a side of the arm generally perpendicular to a length of the arm. The shape of the ice moving paddles 40 is such that when fabrication of the agitator is complete and the agitator is mounted on the drive motor output shaft 45, the paddles will extend into and generally conform in shape to the ice bin ice directing trough 31.

As cut from flat metal stock, the ice dispense agitator 32 also includes two generally rectangular ice agitating blades 42 that are joined to the sides of associated diametrically opposed ice sweeping arms 36 and extend outward therefrom perpendicular to the length of the arms, although if desired or required, an ice agitating blade could be provided for each ice sweeping arm. Each ice agitating blade 42 has a length extending generally perpendicular to and a width extending generally parallel to a length of its associated ice sweeping arm and is integrally joined to its associated ice sweeping arm along only a portion of its width. In particular, each ice agitating blade 42 is connected to its associated ice sweeping arm 36 only from an end of its width toward the central hub 38 to a point radially outward therefrom that is short of the full width of the blade. In consequence, an unconnected open area 46 then exists between an end edge portion E of the ice agitating blade and its associated ice sweeping arm outward from the radially outward point to the opposite end of the width of the blade, which end edge portion E extends along and adjacent the ice sweeping arm.

While not a physical part of the structure of the agitator 32, each ice sweeping arm 36 has a bend line A extending across its width generally medially of the length of the arm and a bend line B extending along its length between the side of the arm and its ice sweeping paddle portion 40, as represented in dashed lines. Each ice agitating blade 42 has a bend line C extending along its width and along the length of its associated ice sweeping arm at its juncture with the arm and a bend line D extending along its length just radially outward from the radially outer end of the bend line C, also as represented in dashed lines.

To form a finished ice dispense agitator 32 from the flat metal agitator depicted in FIG. 3, the flat metal agitator, the individual elements of which are initially coplanar, is subjected to bending operations. The outer end portions 43 of the ice sweeping arms 36 are bent downward along the bend lines A to an angle on the order of from about 45° to form angled end portions 43 and the paddle portions 40 are bent upward along the bend lines B to an angle of about 90° with the end portions 43 to form the paddles 40, such that the planes of the paddles then extend generally transverse to the planes of the remainder of the ice sweeping arms, including the planes of the angled portions 43. The shape of the paddles 40 and the angles of bend about the bend lines A and B are determined by the configuration of the ice bin trough 31, such that when the agitator is mounted on the drive motor output shaft 45 within the interior 25 of the ice bin 24, the angled arm portions 43 and the paddles 40 extend into, generally conform in shape to and freely sweep within and through the ice bin trough 31. The ice agitating blades 42, in turn, are bent along the bend lines C out of the plane of the ice sweeping arms 36 and to an angle on the order of about 90° with the ice sweeping arms, so that the blades then extend transverse to their associated ice sweeping arms. In addition, flange portions of the ice agitating blades 42 are bent along the bend lines D to an angle on the order of about 90° to form the ice agitating blades 42 to an “L” shape.

Upon completion of the bending process to form the ice dispense agitator 32 to its final shape, the ice agitating blades 42, which are integrally attached to the ice sweeping arms 36 along the bend lines C, are welded to the arms along their end edge portions E to fill the open unconnected area between the blades and arms with weld material that securely attaches the flange portions of the blades to the ice sweeping arms for enhanced strength and rigidity of the connection of the blades to the arms. In addition, a drive bushing 44 is welded to the agitator hub 38 over the square opening 39 to provide increased strength for the mechanical connection between the agitator and the drive shaft 45 of the agitator drive motor 29. The ice dispense agitator 32 can then be placed into the ice retaining bin 24 and attached to the drive motor shaft.

From the foregoing, it may be appreciated that manufacture of the ice dispense agitator 32 can be done quickly and with a minimum of operations, thereby greatly lowering the cost of fabricating the agitator. This represents a particular improvement over known agitators that are assembled and welded from a number of individual parts, since in fabricating the agitator 32, welds are required only to connect the end edge portions E of the ice agitator blades 42 to the adjacent ice sweeping arms 36, and to attach the drive bushing 44 to the agitator hub 38. It is understood that while the invention has been described in connection with an ice dispense agitator having the configuration of the agitator 32, the teachings of the invention can be used with other agitator configurations as well, such as with agitators having four ice agitating blades 42 instead of two, with each blade then being attached to an associated one of four ice sweeping arm 36.

While embodiments of the invention have been described in detail, various modifications and other embodiments thereof may be devised by one skilled in the art without departing from the spirit and scope of the invention, as defined in the appended claims.

What is claimed is:

1. An ice dispense agitator, comprising,
a unitary agitator body cut from flat metal stock, said agitator body having a plurality of ice sweeping arms extending outward from a central hub and each said ice sweeping arm having an ice moving paddle at an end thereof that is attached to said ice sweeping arm by a bent portion of said ice sweeping arm.

2. An ice dispense agitator as defined in claim 1, said unitary agitator body having at least one ice agitating blade attached to said agitator body by a bent portion of said agitator body and extending in a direction out of a plane of said ice sweeping arms.

3. An ice dispense agitator as defined in claim 2, said at least one ice agitating blade extending in a direction generally transverse to the plane of said ice sweeping arms and having a flange portion, said flange portion having an end edge portion extending along and adjacent a portion of said agitator body and being welded to said adjacent agitator body portion.

4. An ice dispense agitator, comprising:
a unitary agitator body cut from flat metal stock, said agitator body having a central hub that is rotatable about an axis, a plurality of ice sweeping arms extending radially outward from said hub in angular spaced relationship, and an ice moving paddle at an end of each said ice sweeping arm and attached to said end of said ice sweeping arm by a bent portion of said ice sweeping arm.

5. An ice dispense agitator as in claim 4, said unitary agitator body further having at least one ice agitating blade connected at one end thereof to an associated one of said ice sweeping arms by a bent portion of said agitator body and extending in a direction out of a plane of said associated ice sweeping arm.

6. An ice dispense agitator as in claim 5, said at least one ice agitating blade extending in a direction generally transverse to a direction of extension of said associated ice sweeping arm, being L-shaped and including a pair of legs attached by a bent portion of said ice agitating blade, one leg of said L-shaped blade being connected to said associated ice sweeping arm by said bent portion of said agitator body and the other leg of said L-shaped blade having an end edge portion that extends along and adjacent said associated one of said ice sweeping arms, said end edge portion being welded to said adjacent ice sweeping arm.

7. An ice dispense agitator fabricated from flat metal stock that is cut and bent, comprising:
a unitary agitator body cut from the metal stock, said agitator body, as cut from the metal stock, including the coplanar elements of a central hub having an axis of rotation, a plurality of elongate ice sweeping arms extending radially outward from said hub in angular spaced relationship, and at least one elongate ice agitating blade extending outward from a side edge of an associated one of said ice sweeping arms,
said agitator comprising said unitary agitator body in which an end portion of each said ice sweeping arm is attached to the remainder of said arm by a bent portion of said arm to provide an ice moving paddle on an end of each said ice sweeping arm, and in which said at least one ice agitating blade is attached to said side edge of said associated ice sweeping blade by a bent portion of said agitator body so that the plane of said at least one ice agitating blade extends out of the plane of said associated ice sweeping arm.

8. An ice dispense agitator as in claim 7, wherein the plane of said ice agitating blade extends generally transverse to the plane of said associated ice sweeping arm.

9. An ice dispense agitator as in claim 7, wherein said at least one ice agitating blade is L-shaped and has a pair of legs attached by a bent portion of said ice agitating blade, one leg of said L-shaped blade is connected to said associated ice sweeping arm by said bent portion of said agitator body and the other leg of said L-shaped blade has an end edge portion that extends along and adjacent said associated one of said ice sweeping arms, said end edge portion being welded to said adjacent ice sweeping arm.

10. A method of fabricating an ice dispense agitator, comprising the steps of:
cutting a unitary agitator body from flat metal stock to provide the unitary agitator body with a central hub and a plurality of ice sweeping arms extending outward from the central hub; and
bending a portion of an outer end of each ice sweeping arm to form an ice moving paddle on the outer end of each ice sweeping arm.

11. A method as in claim 10, wherein said cutting step provides the unitary agitator body with at least one ice agitating blade that is coplanar with and extends outward from an associated one of the ice sweeping arms, and including the further step of bending the ice agitating blade out of coplanar relationship with its associated ice sweeping arm.

12. A method as in claim 11, wherein said cutting step provides the ice agitating blade with a flange portion having an end edge portion that, upon performance of said step of bending the ice agitating blade, extends along and adjacent a portion of the associated ice sweeping arm, and including the further step of welding the end edge portion to the associated ice sweeping arm.

13. A method of fabricating an ice dispense agitator, comprising the steps of:
cutting a unitary agitator body from flat metal stock to provide the unitary agitator body with coplanar elements including a central hub having an axis of rotation, a plurality of elongate ice sweeping arms extending radially outward from the hub in angular spaced relationship, and at least one elongate ice agitating blade extending outward from a side edge of an associated one of the ice sweeping arms;
bending a portion of an outer end of each ice sweeping arm to form an ice moving paddle on the outer end of each ice sweeping arm; and
bending the at least one ice agitating blade out of coplanar relationship with its associated ice sweeping arm.

14. A method as in claim 13, wherein said step of bending the at least one ice agitating blade brings the plane of the ice agitating blade into generally transverse relationship with the plane of the associated ice sweeping arm.

15. A method as in claim 14, including the further step of bending the at least one ice agitating blade along its length to an L-shape, such that one leg of the L-shaped blade has an end edge portion that extends along and directly adjacent the associated one of the ice sweeping arms, and including the further step of welding the one edge portion to the associated ice sweeping arm.

16. A method of fabricating an ice dispense agitator, comprising the steps of:
cutting a unitary agitator body from flat metal stock to provide the unitary agitator body with coplanar elements including a central hub having an axis of rotation, a plurality of elongate ice sweeping arms extending radially outward from the hub in angular spaced relationship and having end portions and transverse extensions at the end portions, and at least one elongate ice agitating blade extending transversely from a side of an associated one of the ice sweeping arms intermediate the hub and the end portion of the associated ice sweeping arm and having an end edge portion that extends along and adjacent the side of the associated ice sweeping arm;
bending the end portion of each ice sweeping arm out of the plane of the part of the ice sweeping arm between the end portion and the central hub;
bending the transverse extension of each ice sweeping arm out of the plane of the end portion of the ice sweeping arm; and
bending the at least one ice agitating arm out of the plane of its associated ice sweeping arm.

17. A method as in claim 16, wherein said unitary agitator body has an upper surface, said step of bending the end portion of each ice sweeping arm bends the end portion downward out of the plane of the part of the ice sweeping arm between the end portion and the central hub, said step of bending the transverse extension of each ice sweeping arm bends the transverse extension upward out of the plane of the end portion of the ice sweeping arm, and said step of bending the at least one ice agitating blade bends the at least one ice agitating blade upward out of the plane of its associated ice sweeping arm.

18. A method as in claim 17, wherein said step of bending the end portion of each ice sweeping arm bends the end portion downward on the order of about 30° to 60° out of the plane of the part of the ice sweeping arm between the end portion and the central hub.

19. A method as in claim 17, wherein said set of step of bending the transverse extension of each ice sweeping arm bends the transverse extension upward on the order of about 90° out of the plane of the end portion of the ice sweeping arm.

20. A method as in claim 17, wherein said step of bending the at least one ice agitating blade bends the at least one ice agitating blade upward on the order of about 90° out of the plane of its associated ice sweeping arm.

21. A method as in claim 16, wherein said at least one ice agitating blade comprises a plurality of ice agitating blades, each extending transversely from a side of an associated one of the ice sweeping arms.

22. A method as in claim 16, including the further step of bending the at least one ice agitating blade along its length to be L-shaped, such that the bent leg of the L-shaped blade has the end edge portion and the end edge portion extends along and adjacent the associated one of the ice sweeping arms, and including the further step of welding the end edge portion to the associated ice sweeping arm.
